(19) United States
(12) Patent Application Publication
(10) Pub. No.: US 2004/0074835 A1
(43) Pub. Date: Apr. 22, 2004

(54) Dewatering system

(76) Inventors: Katsuhiko Yoshimoto, Kobe-shi (JP); Masaichiro Nishie, Kobe-shi (JP); Shigeyuki Yoshida, Kobe-shi (JP)

Correspondence Address: Reed Smith, LLP, Suite 1400, 3110 Fairview Park Drive, Falls Church, VA, 22042, US

(21) Appl. No.: 10/649,934

(22) Filed: Aug. 28, 2003

(30) Foreign Application Priority Data
May 30, 2001 (JP) 2001-162441

(51) Int. Cl. B30B 9/20; B01D 25/00; B01D 33/00; B01D 33/58; B01D 35/16

(52) U.S. Cl. 210/396; 100/121

(57) ABSTRACT

A dewatering system for dewatering a material includes a pressure roller dewatering apparatus that includes two dewatering rollers parallel to each other, the distance between which is freely adjustable, and at least one water-absorbent draw-in member provided on the external periphery of the dewatering roller; a water content-controlling unit for dewatering the material until the water content of the material is reduced to a liquid limit or lower and for supplying the resulting water-content-controlled dewatered material between the two dewatering rollers, the water content-controlling unit being disposed upstream of the pressure roller dewatering apparatus; and a roller recycling unit for removing adhering matter and water from the draw-in member.

### BACKGROUND OF THE INVENTION

1. Field of the Invention

The present invention relates to an improved dewatering system for dewatering dredged soils from dams, lakes, rivers, and the like, soils produced by construction, and sludge from industrial wastewater and sewage. In particular, it related to a pressure roller dewatering system in which the amount of the extracted water returning to the supply-side of the pressure roller dewatering apparatus is reduced, the performance of two dewatering rollers for drawing in the material between the dewatering rollers is improved, and the amount of the undewatered material is reduced.

2. Description of the Related Art

Dredged soils from dams, lakes, rivers, and the like, soils produced by construction, and sludge from industrial wastewater and sewage, for example, are dewatered by a dewatering apparatus into cakes before they are subjected to appropriate treatment. In processing dredged soils from dams, lakes, rivers, and the like, and soils produced by construction, sand and gravel are first removed by a sand/gravel separator, and the remainder, i.e., silt having a grain size ranging from 74 to 5 μm, is blended with clay having a grain size less than 5 μm in a sludge conditioning tank. Water is then extracted from the conditioned sludge consisting of the silt and the clay using a thickener, and the resulting sludge is further dewatered with a dewatering apparatus into cakes. The resulting cakes may be effectively used in civil engineering works such as in farmlands, mounding, and the like or may be used as a material of sintered products such as bricks, aggregates, and the like. Sludge in industrial wastewater and sewage, which has properties different from those of the dredged soils from dams, lakes, rivers, and the like and soils produced by construction, are dewatered into cakes, incinerated in incinerators to reduce the volume, and sent to landfill disposal.

Various types of dewatering apparatuses that can dewater mud and sludge to produce cakes are available. One example thereof is a pressure roller dewatering apparatus having a pair of dewatering rollers for dewatering sludge by rolling. Publicly known examples of the pressure roller dewatering apparatuses include Japanese Unexamined Patent Application Publication No. 2000-15297 (Prior Art 1) and Japanese Unexamined Patent Application Publication No. 2001-47099 (Prior Art 2). The pressure roller dewatering apparatus of Prior Art 1 and the sludge dewatering system of Prior Art 2 will now be briefly described.

A pressure roller dewatering apparatus of Prior Art 1 has a pair of dewatering rollers that have rotating shafts arranged in the same horizontal plane and are separated from each other by a predetermined gap therebetween. Each dewatering roller is wrapped in a roller surface material, i.e., a nonwoven polyester filter cloth containing stainless steel, having a thickness of 1.5 mm, which functions as a draw-in member. A feed hopper is disposed to extend perpendicular with respect to the dewatering rollers. The feed hopper has a water outlet at its upper end and a material feed port at its lower end. The material feed port has an arc-shaped notch having a radius slightly larger than the total of the radius of the dewatering roller and the thickness of the roller surface material.

A material placed in the feed hopper is fed from the material feed port to onto the dewatering rollers so as to be spread over the entire length of the dewatering roller in the longitudinal direction.

Each dewatering roller has two air jet nozzles at the two ends. Each air jet nozzle is directed along a tangential line of the lower peripheral surface of the dewatering roller and sends an air jet toward the dewatered cake discharged downwardly from the gap between the dewatering rollers so as to prevent separated water that flows along the end face of the dewatering roller to come into contact with the dewatered cake. The dewatering roller also has a scraper for scraping off the cake adhering to the roller surface material. A slight gap is formed between the blade edge of the scraper and the surface of the roller surface material so as to prevent the roller surface material from being damaged.

This publication, i.e., Japanese Unexamined Patent Application Publication No. 2000-15297, also teaches other implementations. For example, it teaches an apparatus having a feed hopper with a narrow feed port that can supply a material to be dewatered onto only the center portion of the dewatered rollers in the longitudinal direction; an apparatus including two pairs of comb-shaped gates that are disposed to sandwich a feed port for a material to be dewatered in a longitudinal direction so as to allow separated water to flow through water drainage paths between teeth of the combs; an apparatus including grit-shaped gates so as to allow separated water to flow through gaps in the grit; an apparatus including gates, in which gaps are formed between the lower edges of the gates and dewatering rollers to allow separated water to flow through the gaps; and an apparatus including gates with holes through which separated water is drained.

A sludge dewatering system according to Prior Art 2 will now be described. The sludge dewatering system has a pressure roller dewatering apparatus having a pair of parallel dewatering rollers provided with roller surface materials at their outer peripheries. The apparatus is also equipped with a feed hopper. A material to be dewatered is transferred from a primary sludge tank and a conditioning tank, is then fed onto a gravity dewatering conveyor, and is supplied to the feed hopper. The feed hopper is provided with side plates having comb-shaped lower portions. Undewatered sludge produced from the water separated from the material is allowed to flow out through the gaps between teeth of the combs. Moreover, a roller pressurizing mechanism for controlling the pressure applied to the dewatering rollers is provided to adjust the dewatering rate. Furthermore, a scraper for scraping off the dewatered cakes adhering to the roller surface material is provided at a position remote from the rolling position.

According to the sludge dewatering system of Prior Art 2, the undewatered sludge drained through the teeth of the pressure roller dewatering apparatus returns to the conditioning tank at the upper stream of the gravity dewatering conveyor. The returned undewatered sludge is mixed with sludge supplied from the original sludge tank and is again transferred by the gravity dewatering conveyor onto the feed hopper. In other words, according to Prior Art 2, only the material which has been dewatered to an extent that the material cannot flow through the teeth is dewatered with the pressure roller dewatering apparatus. According to this technique, undewatered sludge is prevented from being drained out of the system, and the water content of the sludge, i.e., the material to be dewatered, can be reduced.

Both the pressure roller dewatering apparatus of Prior Art 1 and the sludge dewatering system of Prior Art 2 can produce cakes of predetermined characteristics. However, the pressure roller dewatering apparatus of Prior Art 1 and the sludge dewatering system of Prior Art 2 have the following problems that need to be overcome.

First, in a pressure roller dewatering apparatus of Prior Art 1, water separated from the material to be dewatered stays in the feed hopper and inhibits the material from being drawn between the dewatering rollers. Moreover, since there is a slight gap between the surface material of the dewatering roller and the scraper, the cake adhering to the roller surface material cannot be completely removed, and the cakes once dewatered would be rolled again and again. As a result, the performance of the roller surface materials to draw the material in between the dewatering rollers is degraded, and the dewatered cake recovery rate becomes lower.

Second, in the sludge dewatering system of Prior Art 2, the dewatering performance of the gravity dewatering conveyer is insufficient, and the amount of remaining water, i.e., the amount of the water to be separated by subsequent rolling, is thereby large. Thus, as in Prior Art 1, the material to be dewatered is inhibited from being drawn between the dewatering rollers. Moreover, the drained undewatered sludge amounts to 20 to 80 percent by weight of the entire sludge, which is significantly high. The recovery rate and the dewatering performance were also insufficient since a slight gap is formed between the roller surface material of the dewatering roller and the scraper.

### SUMMARY OF THE INVENTION

An object of the present invention is to provide a dewatering system that can reduce the amount of separated water in the feeder side of the pressure roller dewatering apparatus, can improve the capacity of drawing the material to be dewatered between the dewatering rollers, and can thereby enhance the dewatering performance.

The present invention achieves this object by providing a dewatering system for dewatering a material, the system including a pressure roller dewatering apparatus that includes two dewatering rollers parallel to each other, the distance between which is freely adjustable, and at least one water-absorbent draw-in member provided on the external periphery of the dewatering roller; a water content-controlling unit for dewatering the material until the water content of the material is reduced to a liquid limit or lower and for supplying the resulting water-content-controlled dewatered material between the two dewatering rollers, the water content-controlling unit being disposed upstream of the pressure roller dewatering apparatus; and a roller recycling unit for removing adhering matter and water from the draw-in member.

### BRIEF DESCRIPTION OF THE DRAWINGS

FIG. 1 is a schematic side view for explaining a dewatering system according to a first embodiment of the present invention;

FIG. 2 is a graph for explaining the relationship between the thickness of a dewatered cake and the water content of a material to be dewatered; and

FIG. 3 is a schematic side view for explaining a dewatering system according to a second embodiment of the present invention.

### DESCRIPTION OF THE PREFERRED EMBODIMENTS

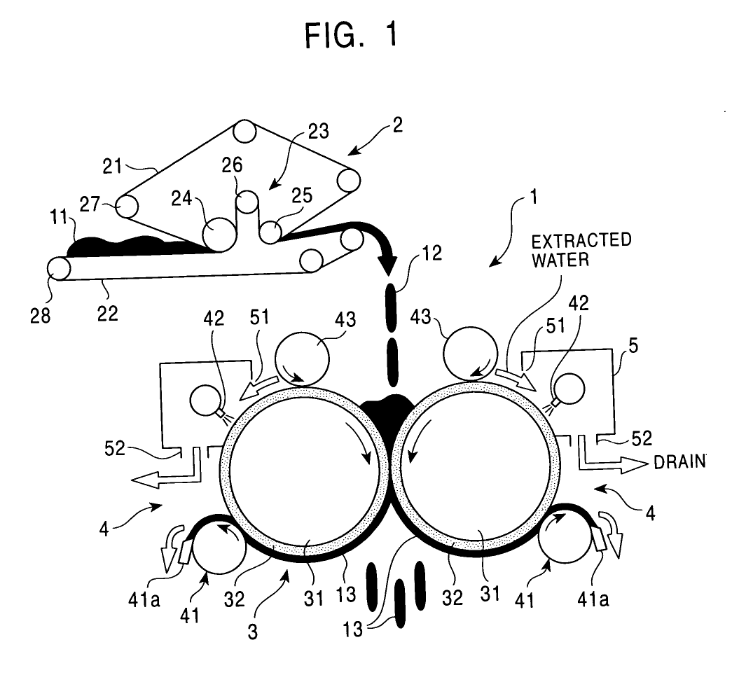

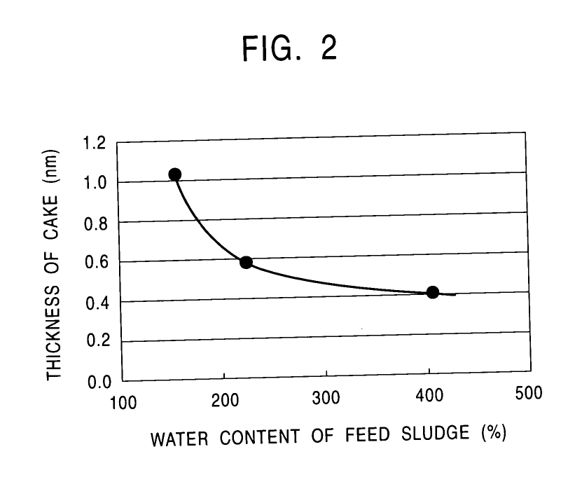

A dewatering system according to a first embodiment of the present invention will now be described with reference to FIGS. 1 and 2. FIG. 1 is a schematic side view for explaining the dewatering system, and FIG. 2 is a graph showing the relationship between the water content of the sludge, i.e., the material to be dewatered, and the thickness of the cake.

Referring now to FIG. 1, a dewatering system 1 of the first embodiment includes a primary sludge tank (not shown), a sludge conditioning tank (not shown), a flocculant addition unit for adding a flocculant (not shown), a belt press dewatering apparatus 2, and a pressure roller dewatering apparatus 3. A material to be dewatered fed from the primary sludge tank is passed through the conditioning tank and the flocculant addition unit to form flocculated sludge 11. The flocculated sludge is then fed onto the belt press dewatering apparatus 2 to adjust the water content. At this stage, the flocculated sludge is dewatered to or below the liquid limit by the belt press dewatering apparatus 2 to form water content-controlled sludge 12. The liquid limit is the water content at which soil changes from a plastic state to a liquid state determined by the testing method set forth in Japanese Geotechnical Society Standards JGS 0141. The water content-controlled sludge 12 is then fed to the pressure roller dewatering apparatus 3.

The belt press dewatering apparatus 2 includes an upper belt 21 and a lower transfer/dewatering belt 22 each stretched over a plurality of rollers. A dewatering unit 23 for squeezing out water from the flocculated sludge 11 placed between the upper belt 21 and the lower transfer/dewatering belt 22 is provided near the center of the belt press dewatering apparatus 2 in the running direction. The dewatering unit 23 is constituted from an entry common roller 24, a delivery common roller 25, and an intermediate common roller 26 placed between the entry common roller 24 and the delivery common roller 25 and at a position higher than those of the entry common roller 24 and the delivery common roller 25. The upper belt 21 and the lower transfer/dewatering belt 22 are both stretched over the entry common roller 24, the delivery common roller 25, and the intermediate common roller 26, the upper belt 21 thereby coming on the top of the lower transfer/dewatering belt 22 in this region.

Tension is applied to the upper belt 21 from an upper tension roller 27 illustrated at the left side of the drawing in FIG. 1, and to the lower transfer/dewatering belt 22 from a lower tension roller 28 illustrated at the left side of the drawing in FIG. 1 so as to adjust the squeezing (dewatering) force applied to the flocculated sludge 11. In particular, the positions of the upper and lower tension rollers 27 and 28 are adjusted to control the tension to the upper belt 21 and the lower transfer/dewatering belt 22 and to thereby freely adjust the water content of the flocculated sludge 11. The lower transfer/dewatering belt 22 is, for example, a filter cloth composed of polyester, nylon, or the like.

In other words, the distance between the flocculated sludge 11 placed on the lower transfer/dewatering belt 22 and the upper belt 21 decreases as the flocculated sludge 11 on the lower transfer/dewatering belt 22 is transferred to approach the dewatering unit 23. In the dewatering unit 23, the flocculated sludge 11 is squeezed between the upper belt 21 and the lower transfer/dewatering belt 22 until the water content is reduced to the liquid limit or lower. The flocculated sludge 11 passed through the dewatering unit 23 forms the water content-controlled sludge 12. As the water content-controlled sludge 12 is transferred by the lower transfer/dewatering belt 22, the distance between the upper belt 21 and the water content-controlled sludge 12 gradually increases. The water content-controlled sludge 12 eventually falls between the two dewatering rollers of the pressure roller dewatering apparatus 3 described below.

The pressure roller dewatering apparatus 3 has two dewatering rollers 31 parallel to each other that roll the water content-controlled sludge 12 supplied from the belt press dewatering apparatus 2. The distance between the dewatering rollers 31 can be freely adjusted. The dewatering rollers 31 are pressurized with a pressurizing unit (not shown) and driven by a driver (not shown). The outer peripheral surface of each dewatering roller 31 is covered with a roller surface material 32, which is a draw-in member. The roller surface material 32 is composed of polyester, nylon, or a felt of, for example, a fiber, and is water absorbent. The efficiency of dewatering sludge increases with the diameter of the dewatering roller 31. Thus, in order to meet an increase in the amount of extracted water, the thickness of the roller surface material 32 must be increased. For example, when the diameter of the dewatering roller 31 is 360 mm, the thickness of the roller surface material 32 should be 7 mm. When the diameter of the dewatering roller 31 is 1,080 mm, the thickness of the roller surface material 32 should be 20 mm.

The pressure roller dewatering apparatus 3 further includes roller recycling units 4. Each roller recycling unit 4 includes a transfer roller 41 for scraping off the cake from the surface of the roller surface material 32, cleaning nozzles 42 for spraying water to clean the roller surface material 32 after the cake is scraped off from the surface of the roller surface material 32, and a squeezer roller 43 for rolling the roller surface material 32 to extract absorbed separated water and washing water from the roller surface material 32.

The transfer rollers 41 have a smaller diameter than the dewatering rollers 31, are made of metal, and have a smooth surface. The transfer rollers 41 are placed opposite to each other against the dewatering rollers 31 at positions approximately 45 degrees downward with respect to the line joining the rotation axes of the dewatering rollers 31 and make contact with the dewatering rollers 31, as shown in FIG. 1. This arrangement prevents damage on the roller surface materials 32 and effectively allows cakes to separate from the roller surface materials 32. The cakes transferred onto the surface of each transfer roller 41 are scraped off with a scraper 41a.

A header having a plurality of cleaning nozzles 42 aligned at a predetermine interval is provided parallel to each dewatering roller 31. The cleaning nozzles 42 oppose the dewatering rollers 31 from positions approximately 30 degrees upward with respect to the line joining the rotation axes of the dewatering rollers 31, as shown in FIG. 1. Each cleaning nozzle 42 sprays washing water at a high pressure, i.e., 0.49 to 0.69 MPa, toward the surface of the dewatering roller 31 from the aperture directed to the rotation axis of the dewatering roller 31 so as to wash away the remaining cake and the microparticles of the cake. In this manner, even when the cake or microparticles of the cake on the roller surface material 32 are not completely removed due to irregularity in transferring the cake to the transfer roller 41, the capacity of the roller surface material 32 to draw in the water content-controlled sludge 12 between the rollers can be substantially restored to the initial state.

As with the transfer rollers 41, the squeezer rollers 43 have a smaller diameter than the dewatering rollers 31, are made of metal, and have smooth surfaces. The squeezer rollers 43 are placed at positions above the dewatering rollers 31 and are pressed against the dewatering rollers 31 at a bearing stress higher than that between the dewatering rollers 31 so as to extract the separated water and the washing water absorbed in the roller surface materials 32 by rolling. As a result, the capacity of the dewatering rollers 31 to absorb the water separated from the flocculated sludge can be restored to the initial state.

The roller recycling unit 4 further includes drain units, i.e., water collecting/draining boxes 5. Each water catching/draining box 5 accommodates the header and the cleaning nozzles 42. The water sprayed from the cleaning nozzles 42 and splashed back at the roller surface material 32 and the water extracted by the squeezer roller 43 and flowing down along the surface of the roller surface material 32 are allowed to flow into the water catching/draining box 5 via an incurrent opening 51 and are collected in the water catching/draining box 5. The collected water is drained from a drain hole 52 disposed at the lower portion of the water catching/draining box 5 without having to leak toward the transfer roller 41.

The water drained outside the system through the drain hole 52 is transferred to a sedimentation basin or a sedimentation tank and purified to be recycled as the washing water.

The transfer roller 41, the cleaning nozzle 42, and the squeezer roller 43 of the roller recycling unit 4 must be arranged in order along the rotation direction starting from the rolling position of the dewatering roller 31. Specific positions and angles of these components are not limited to those described above.

The operation of the dewatering system of this embodiment will now be described. The sludge from the primary sludge tank is conditioned in the conditioning tank and is transferred to the flocculant addition unit where a flocculant is added. The resulting flocculated sludge is fed onto the lower transfer/dewatering belt 22 of the belt press dewatering apparatus 2. The tension of the upper belt 21 and the lower transfer/dewatering belt 22 of the belt press dewatering apparatus 2 is adjusted by an upper tension roller 27 and a lower tension roller 28 so as to apply a rolling pressure that can dewater the flocculated sludge 11 to the liquid limit or below. As a result, the flocculated sludge 11 placed on the lower transfer/dewatering belt 22 is dewatered to the liquid limit or lower by the dewatering unit 23.

Various types of flocculated sludge having different water contents were dewatered using the dewatering rollers 31 having a diameter of 120 mm at an applied pressure of 1,000 N and the thickness of the resulting cakes was measured. The relationship between the cake thickness and the water content of the sludge is shown in FIG. 2. As shown in FIG. 2, the larger the water content of the sludge, the thinner the cake. The smaller the water content of the sludge, the thicker the cake. The liquid limit of the sludge shown in FIG. 2 is 190%, and the thickness of the cake dramatically increases at water contents less than about 190%. When the cake has increased thickness, the cake can be effectively introduced between the dewatering rollers 31. In view of the above, in the present invention, the flocculated sludge is dewatered by the belt press dewatering apparatus 2 until the water content thereof is reduced to the liquid limit, i.e., 190%, or lower to make the water content-controlled sludge 12 before the sludge is fed to the pressure roller dewatering apparatus 3. As is described above, the feature of the present invention is to adjust the water content of the sludge to be fed to the pressure roller dewatering apparatus 3 based on the relationship between the water content of the sludge and the thickness of the cake while taking into account the liquid limit. This advantage cannot be achieved by Prior Art 2 previously mentioned since the gravity dewatering conveyer having low dewatering capacity supplies sludge having a water content equal to or greater than the liquid limit (190% or more in the case shown in FIG. 2) to the roller dewatering apparatus, thereby inhibiting the dewatering rollers of the pressure roller dewatering apparatus to draw in the sludge. As a result, the thickness of the dewatered cake would be small.

In the present invention, the water content-controlled sludge 12 having the water content reduced to the liquid limit, i.e., 190%, or below is supplied from the belt press dewatering apparatus 2 to the pressure roller dewatering apparatus 3. Thus, the water content-controlled sludge 12 can be effectively drawn between the dewatering rollers 31 to form a cake 13. Part of the cake 13 immediately falls down while the remainder adheres onto the roller surface materials 32 of the dewatering rollers 31. The pressure applied by rolling the water content-controlled sludge 12 causes water to separate from the water content-controlled sludge 12. The separated water is absorbed by the roller surface materials 32 and thus does not inhibit the water content-controlled sludge 12 from being drawn between the dewatering rollers 31.

The cake 13 adhering to the roller surface material 32 of each dewatering roller 31 reaches the transfer roller 41 of the roller recycling unit 4 as the dewatering roller 31 is rotated. The cake is nearly completely transferred onto the transfer roller 41, i.e., removed from the roller surface material 32. The transferred cake 13 is scraped off from the transfer roller 41 by the scraper 41a. Subsequently, the roller surface material 32 is cleaned by water spray to remove part of the cake or microparticles of the cake remaining in the roller surface material 32. The capacity of the roller surface material 32 to draw in the water content-controlled sludge 12 can thus be restored to the initial state.

The water separated from the material and the washing water both absorbed in the roller surface material 32 are extracted by the squeezer roller 43 to restore the capacity of the roller surface material 32 to absorb the water separated from the flocculated sludge 11. The water extracted by the squeezer roller 43 flows down along the surface of the roller surface material 32 into the water catching/draining box 5 via the incurrent opening 51, and is drained via the drain hole 52 along with the washing water supplied from the cleaning nozzle 42 and splashed back at the roller surface material 32.

According to the dewatering system 1 of the first embodiment, since the water content-controlled sludge 12 supplied to the pressure roller dewatering apparatus 3 contains less water than Prior Art 1 or Prior Art 2, large amounts of water content-controlled sludge 12 can be drawn between the dewatering rollers 31 so as to be dewatered.

Moreover, unlike Prior Art 1 and Prior Art 2, which cannot completely remove the cake from the roller surface material of the dewatering roller, the dewatering system 1 of the first embodiment can completely remove the cake from the roller surface materials 32 of the dewatering rollers 31 since the roller recycling units 4 each including the transfer roller 41, the cleaning nozzle 42, and the squeezer roller 43 is provided. According to the invention, the capacity of the roller surface materials 32 of the dewatering rollers 31 can be restored to or near the initial state. Thus, dewatering of sludge can be stably, effectively performed over long term. The dewatering system 1 of the first embodiment has an advantage of dramatically improving the recovery rate of the cake.

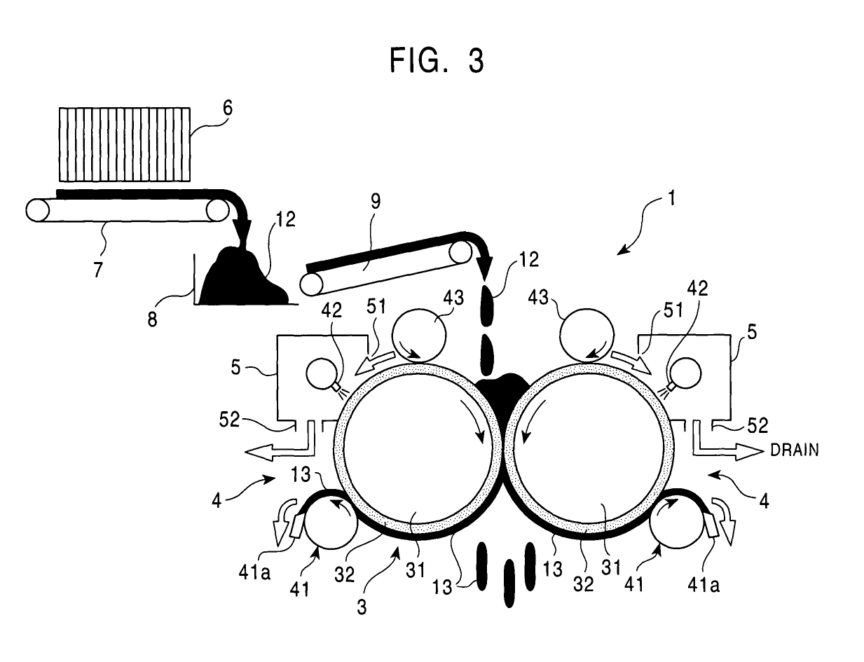

A dewatering system according to a second embodiment of the present invention will now be described with reference to FIG. 3. FIG. 3 is a schematic side view of the dewatering system of the second embodiment. The difference between the first embodiment and the second embodiments lies in the structure of the water content-controlling unit. The structure of the pressure roller dewatering apparatus and the like placed downstream of the water-content controlling unit are identical to those of the first embodiment. In the description below, the same components as those of the first embodiment are represented by the same reference characters and are referred to by the same names.

The dewatering system 1 of the second embodiment has a water content-control unit including a filter press dewatering apparatus 6 and a transfer conveyor 7 that transfers the water content-controlled sludge 12 to a stock yard 8 under the discharge opening of the filter press dewatering apparatus 6. A feeder conveyor 9 for transferring the water content-controlled sludge 12 stocked in the stock yard 8 is also provided to feed the water content-controlled sludge 12 between the dewatering rollers 31 of the pressure roller dewatering apparatus 3.

Note that the stock yard 8 and the feeder conveyor 9 are not essential features of invention. For example, the water content-controlled sludge 12 may be directly supplied between the dewatering rollers 31 of the pressure roller dewatering apparatus 3 by using the transfer conveyor 7.

The only difference from the first embodiment lies in the structure of the water-content controlling unit. Since the water content-controlled sludge 12 whose water content is adjusted to the liquid limit or below is supplied between the dewatering rollers 31 of the pressure roller dewatering apparatus 3 as in the first embodiment, the dewatering system of the second embodiment can achieve the same advantages as those of the first embodiment.

Although the above-described embodiments concern dewatering of sludge, the material to be dewatered by the system is not limited to sludge. For example, the present invention can be applied to dewatering dredged soil of dams, lakes, rivers, and the like, soils produced by construction, and sludge from industrial wastewater and sewage. The material to be dewatered may be any material. Moreover, although in the above-described embodiments, both the dewatering rollers are provided with the roller surface materials at their peripheral surfaces, only one of the dewatering rollers needs to be provided with the roller surface material since sufficient performance can still be achieved. The application of the dewatering system of the present invention is by no means limited by the first and second embodiments described above.

What is claimed is:

1. A dewatering system for dewatering a material, the system comprising:
a pressure roller dewatering apparatus comprising:
two dewatering rollers parallel to each other, the distance between which is freely adjustable, and
at least one water-absorbent draw-in member provided on the external periphery of the dewatering roller;
a water content-controlling unit for dewatering the material until the water content of the material is reduced to a liquid limit or lower and for supplying the resulting water-content-controlled dewatered material between the two dewatering rollers, the water content-controlling unit being disposed upstream of the pressure roller dewatering apparatus; and
a roller recycling unit for removing adhering matter and water from the draw-in member.

2. The system according to claim 1, the roller recycling unit comprising:
a cake removing unit for removing the cake adhering onto the surface of the draw-in member;
a cleaning unit for cleaning the draw-in unit; and
a water removing unit for removing the water absorbed in the draw-in member.

3. The system according to claim 2, wherein the cake removing unit comprises a transfer roller that makes rolling contact with the draw-in member of the dewatering roller.

4. The system according to claim 3, wherein a scraper for scraping off the cake transferred from the draw-in member of the dewatering roller onto the surface of the transfer roller is provided to the transfer roller.

5. The system according to claim 2, wherein the cleaning unit comprises a washing nozzle for spraying water toward the surface of the draw-in member after the cake is removed from the surface of the draw-in member.

6. The system according to claim 2, wherein the water removing unit of the draw-in member comprises a squeezer roller for rolling the draw-in member of the dewatering roller.

7. The system according to claim 1, further comprising a drain unit for collecting water produced by the roller recycling unit and draining the collected water to the outside of the dewatering system.
